(19) United States
(12) Patent Application Publication
(10) Pub. No.: US 2025/0023147 A1
(43) Pub. Date: Jan. 16, 2025

(54) SECONDARY BATTERY MANUFACTURING SYSTEM

(71) Applicant: SK ON CO., LTD., Seoul (KR)

(72) Inventors: Ju Hyeong BAE, Daejeon (KR); Kang San KIM, Daejeon (KR); Sang Jun PARK, Daejeon (KR); Ji Won YANG, Daejeon (KR); Do Wan CHA, Daejeon (KR)

(21) Appl. No.: 18/769,437

(22) Filed: Jul. 11, 2024

(30) Foreign Application Priority Data
Jul. 14, 2023 (KR) 10-2023-0091876

(51) Int. Cl. H01M 50/105; H01M 10/04; H01M 50/536

(52) U.S. Cl. CPC H01M 50/105; H01M 10/0404; H01M 50/536

(57) ABSTRACT

Proposed is a secondary battery manufacturing system including a tab welding unit that performs a welding process on an electrode tab of an electrode assembly and inserts the electrode assembly into a transfer cassette, an inspection unit that inspects the electrode assembly, packaging units provided in parallel for inserting the electrode assembly that has passed the inspection unit into a pouch, a buffer unit that transfers the transfer cassette from the tab welding unit to the inspection unit or stores the transfer cassette, and at least one control unit that controls the electrode assembly supplied from the inspection unit to be selectively supplied to any one packaging unit that operates normally depending on whether the packaging units operate normally, and controls the transfer cassette to be supplied to the inspection unit that operates normally or stored in the buffer unit depending on whether the inspection unit operates normally.

### CROSS REFERENCE TO RELATED APPLICATION

The present application claims priority to Korean Patent Application No. 10-2023-0091876, filed Jul. 14, 2023, the entire contents of which is incorporated herein for all purposes by this reference.

### BACKGROUND OF THE INVENTION

### Field of the Invention

The present disclosure relates to a secondary battery manufacturing system.

### Description of the Related Art

In general, a secondary battery is a battery that can be used repeatedly through the process of discharging that converts chemical energy into electrical energy and charging during which the chemical reactions are reversed. Types of secondary batteries include nickel-cadmium (Ni—Cd) batteries, nickel-hydrogen (Ni-MH) batteries, lithium-metal batteries, lithium-ion (Ni-Ion) batteries, and lithium-ion polymer batteries (hereinafter referred to as “LIPB”), etc.

Recently, secondary batteries have been attracting attention as a popular energy source as they are widely used in IT products, automobiles, and energy storage fields. In the field of IT products, secondary batteries are required to be able to be used continuously and for long stretches of time, and miniaturization and weight reduction are also important, while the automotive field requires high power, durability, and stability to eliminate explosion risks. In the energy storage field, secondary batteries are used for storing excess power produced by wind and solar generation, etc., and since a battery is used in a fixed manner, more relaxed conditions may be applied.

In a typical secondary battery manufacturing system, the operations for each process are performed sequentially to manufacture secondary batteries. This means that a smooth manufacturing system may be achieved only when semi-finished products from the previous stage supplied for each process are continuously supplied to the next process at a constant speed. Therefore, when multiple processes are performed in succession, smooth operation of the manufacturing system may become difficult due to operation stoppages taken depending on the needs of individual processes or failures that occur in any one process.

### DOCUMENTS OF RELATED ART

(Patent Document 0001) Korean Patent No. 10-2278998

### SUMMARY OF THE INVENTION

Accordingly, the present disclosure has been made keeping in mind the above problems occurring in the related art, and the present disclosure is intended to provide a secondary battery manufacturing system that effectively increases the productivity of a tab welding unit, an inspection unit, and a packaging unit of the secondary battery manufacturing system.

In addition, by diversifying the supply of electrode assemblies between the tab welding unit, the inspection unit, and the packaging unit processes, the production line may be stably operated without stopping the entire production system due to any one process.

In order to achieve the above objective, according to an embodiment of the present disclosure, there is provided a secondary battery manufacturing system including: a tab welding unit configured to perform a welding process on an electrode tab of an electrode assembly and insert the electrode assembly into a transfer cassette; an inspection unit configured to inspect the electrode assembly; packaging units provided in parallel for inserting the electrode assembly that has passed the inspection unit into a pouch; a buffer unit configured to transfer the transfer cassette from the tab welding unit to the inspection unit or store the transfer cassette; and at least one control unit configured to control the electrode assembly supplied from the inspection unit to be selectively supplied to any one packaging unit that operates normally depending on whether the packaging units operate normally, and control the transfer cassette to be supplied to the inspection unit that operates normally or stored in the buffer unit depending on whether the inspection unit operates normally.

In this case, the buffer unit may include: a transfer buffer part in which the transfer cassette reciprocates between the tab welding unit and the inspection unit; a first storage part where the transfer cassette is stored; and a second storage part where the transfer cassette is stored.

In addition, the control unit may further include: a buffer controller configured to transfer the transfer cassette of the first storage part or the second storage part to the inspection unit when the tab welding unit stops operating.

In addition, the control unit may further include: a buffer controller configured to transfer the transfer cassette to the first storage part or the second storage part when the inspection unit stops operating and the packaging units stop operating.

In addition, the control unit may further include: an inspection controller configured to control a supply speed of the transfer cassette to the inspection unit when at least one of the packaging units stops operating.

In order to achieve the above objective, according to another embodiment of the present disclosure, there is provided a secondary battery manufacturing system including: a first manufacturing line comprising: a first tab welding unit configured to perform a welding process on an electrode tab of an electrode assembly and insert the electrode assembly into a transfer cassette; a first inspection unit configured to inspect the electrode assembly; first packaging units provided in parallel for inserting the electrode assembly that has passed the inspection unit into a pouch; and a first buffer unit configured to transfer the transfer cassette from the first tab welding unit to the first inspection unit or store the transfer cassette; a second manufacturing line comprising: a second tab welding unit configured to perform a welding process on an electrode tab of an electrode assembly and insert the electrode assembly into a transfer cassette; a second inspection unit configured to inspect the electrode assembly; second packaging units provided in parallel for inserting the electrode assembly that has passed the inspection unit into a pouch; and a second buffer unit configured to transfer the transfer cassette from the second tab welding unit to the second inspection unit or store the transfer cassette; a buffer connection unit configured to connect the first buffer unit and the second buffer unit; and at least one control unit configured to transfer the transfer cassette of the first tab welding unit to the first inspection unit or the second inspection unit and transfer the transfer cassette of the second tab welding unit to the first inspection unit or the second inspection unit, and to selectively supply the electrode assembly that has passed the first inspection unit to one of the first packaging units and selectively supply the electrode assembly that has passed the second inspection unit to one of the second packaging units.

In this case, the first buffer unit may include: a first transfer buffer part in which the transfer cassette reciprocates between the first tab welding unit and the first inspection unit; and a 1-1 storage part and a 1-2 storage part where the transfer cassette is stored; the second buffer unit may include: a second transfer buffer part in which the transfer cassette reciprocates between the second tab welding unit and the second inspection unit; and a 2-1 storage part and a 2-2 storage part where the transfer cassette is stored; and the buffer connection unit may be provided to connect the 1-1 storage part or the 1-2 storage part and the 2-1 storage part or the 2-2 storage part.

In addition, the control unit may further include: a buffer controller configured to transfer the transfer cassette of the first buffer unit to the second inspection unit through the buffer connection unit when the first inspection unit of the first manufacturing line stops operating and the first packaging units stop operating, and transfer the transfer cassette of the second buffer unit to the first inspection unit through the buffer connection unit when the second inspection unit of the second manufacturing line stops operating and the second packaging units stop operating, and to store the transfer cassettes of the first tab welding unit and the second tab welding unit in the first buffer unit or the second buffer unit, respectively, when the first inspection unit and the second inspection unit stop operating and the first packaging units and the second packaging units stop operating.

In addition, the control unit may further include: a buffer controller configured to transfer the transfer cassette of the 1-1 storage part or the 1-2 storage part of the first buffer unit to the first inspection unit when the first tab welding unit stops operating, and transfer the transfer cassette of the 2-1 storage part or the 2-2 storage part of the second buffer unit to the second inspection unit when the second tab welding unit stops operating.

In addition, the buffer controller may transfer the transfer cassette of the first tab welding unit to the 2-1 storage part or the 2-2 storage part of the second buffer unit when the first tab welding unit operates and the second tab welding unit stops operating.

In addition, the control unit may further include: a buffer controller configured to transfer at least one transfer cassette stored in the 1-1 storage part or the 1-2 storage part of the first buffer unit and in the 2-1 storage part or the 2-2 storage part of the second buffer unit to the first inspection unit or the second inspection unit when the first tab welding unit and the second tab welding unit stop operating.

The features and advantages of the present disclosure will become more apparent from the following detailed description based on the accompanying drawings.

Prior to this, terms or words used in this specification and claims should not be construed in their usual, dictionary meaning, and must be interpreted with meaning and concept consistent with the technical idea of the present disclosure on the basis of the principle that the inventor can define terminology appropriately to explain his or her invention in the best way possible.

According to an embodiment of the present disclosure, the entire system of a secondary battery manufacturing system can be operated effectively during normal operation of a tab welding unit, an inspection unit, and a packaging unit as well as when the operation of the tab welding unit, the inspection unit, or the packaging unit is stopped.

In addition, the operation of the tab welding unit can be stably maintained when the inspection unit and the packaging unit are operating normally or even when the operation of the inspection unit or the packaging unit is stopped, and a transfer cassette containing an electrode assembly from the tab welding unit can be effectively stored in a buffer unit.

In addition, through the control of effectively transferring an electrode assembly of the tab welding unit to the inspection unit and the packaging unit or storing the electrode assembly in a separate space by means of the buffer unit, the overall lead time of the secondary battery manufacturing system can be optimized by continuously supplying electrode assemblies from the tab welding unit to the next process.

In addition, by appropriately controlling the transport and storage of an electrode assembly from the tab welding unit by means of a packaging controller, the manufacturing reliability of the secondary battery manufacturing system can be ensured through effective operation of the packaging unit.

In addition, by effectively transferring a transfer cassette in which an electrode assembly is stored to the next process or storing the transfer cassette in a separate space by means of the buffer unit, the connection between individual processes of the secondary battery manufacturing system can be effectively achieved.

In addition, by connecting buffer units between multiple manufacturing lines including multiple packaging units, stored transfer cassettes can be effectively transported and input into individual processes of the manufacturing system, thereby ensuring the reliability of the operation of the manufacturing system for mass production.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic view illustrating a secondary battery manufacturing system according to an embodiment of the present disclosure;

FIG. 2 is a schematic view illustrating a secondary battery manufacturing system according to a modified example of an embodiment of the present disclosure;

FIG. 3 is a schematic view illustrating a secondary battery manufacturing system according to another embodiment of the present disclosure;

FIG. 4 is a schematic view illustrating a secondary battery manufacturing system according to a modified example of another embodiment of the present disclosure; and

FIG. 5 is a perspective view illustrating a transfer cassette storing an electrode assembly according to an embodiment of the present disclosure.

### DETAILED DESCRIPTION OF THE INVENTION

The objectives, advantages, and features of the present disclosure will become more apparent from the following detailed description and preferred embodiments taken in conjunction with the accompanying drawings, but the present disclosure is not necessarily limited thereto. In addition, in describing the present disclosure, if it is determined that a detailed description of related known technology may unnecessarily obscure the gist of the present disclosure, the detailed description will be omitted.

It should be noted that, in assigning reference numerals to components in the drawings, identical components are assigned the same reference numerals as much as possible even if they are shown in different drawings, and similar reference numbers are assigned to similar components.

Terms used to describe an embodiment of the present disclosure are not intended to limit the disclosure. It should be noted that singular expressions include plural expressions unless the context clearly dictates otherwise.

In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., used to distinguish one component from another component, and the components are not limited by the terms.

The embodiments described in this document and the accompanying drawings are not intended to limit the disclosed technology to specific embodiments. The disclosed technology should be understood to include various modifications, equivalents, and/or alternatives to the embodiments.

Hereinafter, an embodiment of the present disclosure will be described in detail with reference to the attached drawings.

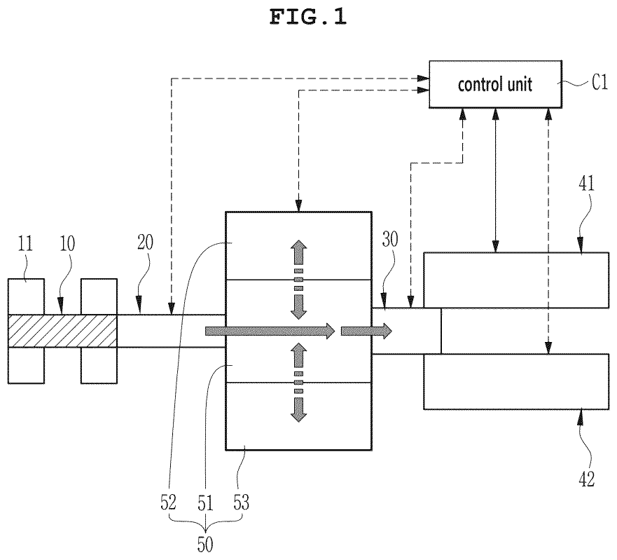

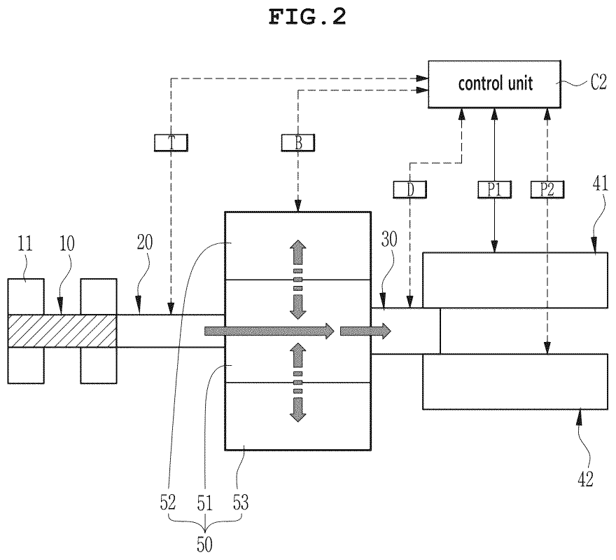

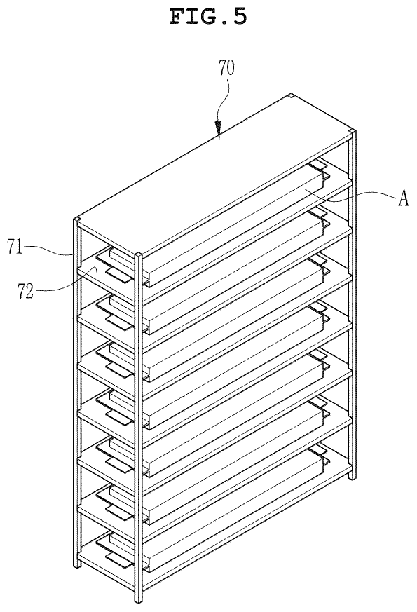

FIG. 1 is a schematic view illustrating a secondary battery manufacturing system according to an embodiment of the present disclosure; FIG. 2 is a schematic view illustrating a secondary battery manufacturing system according to a modified example of an embodiment of the present disclosure; and FIG. 5 is a perspective view illustrating a transfer cassette storing an electrode assembly according to an embodiment of the present disclosure.

A secondary battery manufacturing system according to an embodiment of the present disclosure includes: a tab welding unit 20 configured to perform a welding process on an electrode tab of an electrode assembly and insert the electrode assembly into a transfer cassette 70; an inspection unit 30 configured to inspect the electrode assembly; packaging units 41 and 42 provided in parallel for inserting the electrode assembly that has passed the inspection unit 30 into a pouch; a buffer unit 50 configured to transfer the transfer cassette 70 from the tab welding unit 20 to the inspection unit 30 or store the transfer cassette 70; and at least one control unit C1 configured to control the electrode assembly supplied from the inspection unit 30 to be selectively supplied to any one packaging unit 41 or 42 that operates normally depending on whether the packaging units 41 and 42 operate normally, and to control the transfer cassette 70 to be supplied to the inspection unit 30 that operates normally or stored in the buffer unit 50 depending on whether the inspection unit 30 operates normally.

As shown in FIG. 1, in the secondary battery manufacturing system according to an embodiment of the present disclosure, an electrode assembly manufactured by a plurality of stack devices 11 moves to the tab welding unit 20 through a supply unit 10. The stack device 11 includes a positive electrode plate and a negative electrode plate of an electrode assembly, and an insulating separator laminated between the positive electrode plate and the negative electrode plate, and may manufacture electrode assemblies using various winding methods. An electrode assembly manufactured in the stack device 11 is supplied to the tab welding unit 20 through the supply unit 10.

In the tab welding unit 20, a plurality of electrode plates of the electrode assembly is welded and electrode tabs are formed. As an example, the plurality of exposed electrode plates of the electrode assembly is pre-welded, and then the ends of the electrode plates are cut and trimmed. After trimming the electrode plates, a process of welding the electrode tabs for electrical connection of a secondary battery is performed, and the electrode assembly that has undergone the tab welding process is produced in the tab welding unit 20. The tab welding method for an electrode assembly is not limited thereto and may include various known methods.

The electrode assembly that has been processed in the tab welding unit 20 may be stacked on the transfer cassette 70. As shown in FIG. 5, the transfer cassette 70 may be formed of a plurality of outer vertical frames 71 and a plurality of horizontal plates 72 provided in the stacking direction coupled thereto. Electrode assemblies are sequentially stacked and stored in the transfer cassette 70, and an electrode assembly stacked and stored in the transfer cassette 70 may be effectively taken out and input into the next process. The transfer cassette 70 is not limited to the structure shown in the drawing, and a variety of stacking or storage methods and structures for stacking or storing electrode assemblies may be applied.

When electrode assemblies are stacked on the transfer cassette 70 from the tab welding unit 20, and a predetermined number of electrode assemblies are all stacked and inserted into the transfer cassette 70, the transfer cassette 70 may be transferred to supply an electrode assembly to the next process, or stored in a separate location or waiting for supply.

The inspection unit 30 performs a process of inspecting an electrode assembly. In this case, the inspection unit 30 may include an X-ray part to inspect an electrode assembly in 2D, or inspect an electrode assembly in 3D using a CT (computed tomography) tester. The inspection unit 30 may be composed of inspection equipment for various inspections required before an electrode assembly that has passed through the tab welding unit 20 undergoes packaging work in the packaging units 41 and 42.

The transfer cassette 70 containing electrode assemblies from the tab welding unit 20 is transferred to the inspection unit 30. In this case, the tab welding unit 20 and the inspection unit 30 may be provided as an in-line system formed to be connected in a 1:1 one line process.

Due to this, appropriate design changes are possible to implement an optimized secondary battery manufacturing system that takes into account the production volume of electrode assemblies produced from the tab welding unit 20 and the inspection process time for inspection in the inspection unit 30, etc.

When the transfer cassette 70 is supplied from the tab welding unit 20 to the inspection unit 30, the buffer unit 50 is provided between the tab welding unit 20 and the inspection unit 30. The buffer unit 50 may be configured such that the supply and storage of the transfer cassette 70 may be controlled by the control unit C1 so that the transfer cassette 70 may be transferred from the tab welding unit 20 to the inspection unit 30, or the transfer cassette 70 may not be transferred directly to the inspection unit 30 but may be stored in a separate designated space of the buffer unit 50.

The packaging units 41 and 42 perform a process of inserting the electrode assembly that has passed the inspection unit 30 into a pouch made of a certain material such as aluminum. In this case, the packaging units 41 and 42 are formed in a plurality of parallel configurations after one inspection unit 30 process, so that the entire process may be configured continuously.

An electrode assembly that has passed the inspection unit 30 and was judged normal is appropriately selected and supplied to one of the packaging units 41 and 42 by the control unit C1.

The process speed of each of the plurality of packaging units 41 and 42 may be appropriately adjusted by the supply speed of electrode assemblies supplied from the inspection unit 30. As shown in FIG. 1, when the two packaging units 41 and 42 are connected in parallel from the inspection unit 30, the process speed of each packaging unit 41 and 42 may be set at half the supply speed of electrode assemblies supplied through the inspection unit 30.

The packaging units 41 and 42 consist of a plurality of parallel packaging units, and when the packaging units 41 and 42 are composed of two packaging units as shown, even if the operation of any one of the packaging units 41 and 42 is stopped, electrode assemblies supplied from the inspection unit may be supplied to the remaining one of the packaging units 41 and 42 that is operating normally. This also applies when the packaging unit consists of three or more lines. The packaging units 41 and 42, which are configured in parallel, enable the packaging process of electrode assemblies to be performed smoothly, thereby optimizing the lead time of the secondary battery manufacturing system.

In case when the inspection unit 30 does not operate normally, the control unit C1 may store the transfer cassette 70 supplied from the tab welding unit 20 in a space on one side of the buffer unit 50 without supplying the transfer cassette 70 to the inspection unit 30, or may select a transfer path for supplying the transfer cassette 70 to the inspection unit 30 of another manufacturing line to supply electrode assemblies when multiple manufacturing lines are formed.

By doing so, the operation of the secondary battery manufacturing system of multiple manufacturing lines may be optimized and the production lead time of the production line may be effectively designed.

The control unit C1 may control the entire secondary battery manufacturing system by performing a single integrated control. In addition, the system may include a controller T of the tab welding unit, a controller B of the buffer unit, an inspection controller D of the inspection unit, and packaging controllers P1 and P2 provided to control the packaging units 41 and 42, respectively, so as to control the operation of driving devices of the manufacturing system connected to the respective controllers through communication between the controllers, or to control each of the driving devices as the individual controllers are connected to a single control unit C2 that integrates and controls signals of the individual controllers (see FIG. 2).

The buffer unit 50 may include: a transfer buffer part 51 that provides a supply line through which the transfer cassette 70 is transferred from the tab welding unit 20 to the inspection unit 30; and a first storage part 52 and a second storage part 53 of the buffer unit 50, where the transfer cassette 70 is stored rather than being directly supplied to the inspection unit 30 or where the transfer cassette 70 waits to be supplied to another manufacturing line. The first storage part 52 and the second storage part 53 may be simply placed in opposing positions on one side and the other of the buffer unit 50, or may be appropriately arranged in various arrangements, depending on the physical arrangement and configuration of the buffer unit 50. In the present disclosure, the terms one side and the other do not mean that two members are limited to a structure in which the two members are simply arranged on opposite sides.

When the operation of the inspection unit 30 is stopped, the supply of electrode assemblies from the inspection unit 30 becomes impossible. In this case, the control unit C1 may temporarily stop the operation of the packaging units 41 and 42, and cause the transfer cassette 70 supplied from the tab welding unit 20 to be stored or to wait in the first storage part 52 or the second storage part 53 of the buffer unit 50. At this time, the transfer cassette 70 on standby may be controlled to be transferred to the inspection unit 30 of another manufacturing line, which will be described later.

When the tab welding unit 20 is stopped, the transfer cassette 70 stored and waiting in the buffer unit 50 is controlled to be supplied to the inspection unit 30. If necessary, in the case of multiple manufacturing lines, the transfer cassette 70 stored and waiting in the buffer unit 50 of another manufacturing line may be controlled to be supplied to the inspection unit 30.

As in a modified example of an embodiment of the present disclosure in FIG. 2, the control unit may include each controller of each driving device. That is, the control unit may include the inspection controller D for stopping and operating the inspection unit, and the packaging controllers P1 and P2 that determine whether the packaging units 41 and 42 stop operating and communicate with the controller of the driving device at another stage, and control the operating and stopping of the individual packaging units 41 and 42. The control unit may also include the tab welding unit controller T that controls the operating and stopping of the tab welding unit 20, and the buffer controller B that causes the transfer cassette 70 supplied from the tab welding unit 20 to be stored or to wait in the buffer unit 50, or determines and controls whether to transfer the transfer cassette 70 to the inspection unit 30 on the basis of mutual communication values.

In addition, the inspection controller D may receive signals from the packaging controllers P1 and P2 and control the transfer cassette 70 to adjust the speed at which the transfer cassette 70 is supplied to the inspection unit 30 when at least one of the packaging units 41 and 42 stops operating.

As such, as the controllers of individual components communicate with each other, the organic operation of the individual components may be controlled depending on whether each component is running, and as the controllers of the individual components exchange information in an integrated manner with one control unit C2, the individual driving devices may be controlled through mutual communication.

The method of configuring the control unit into a plurality of individual controllers and the control range of each controller are not limited to the examples shown in the present disclosure, and the control unit may be configured as a single or multiple physical unit, or multiple control units may be interchanged.

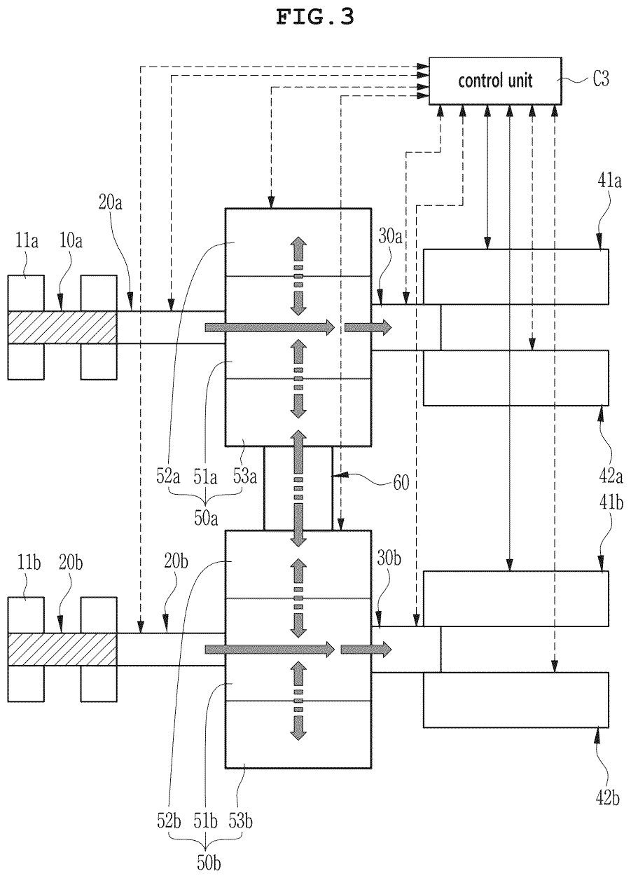

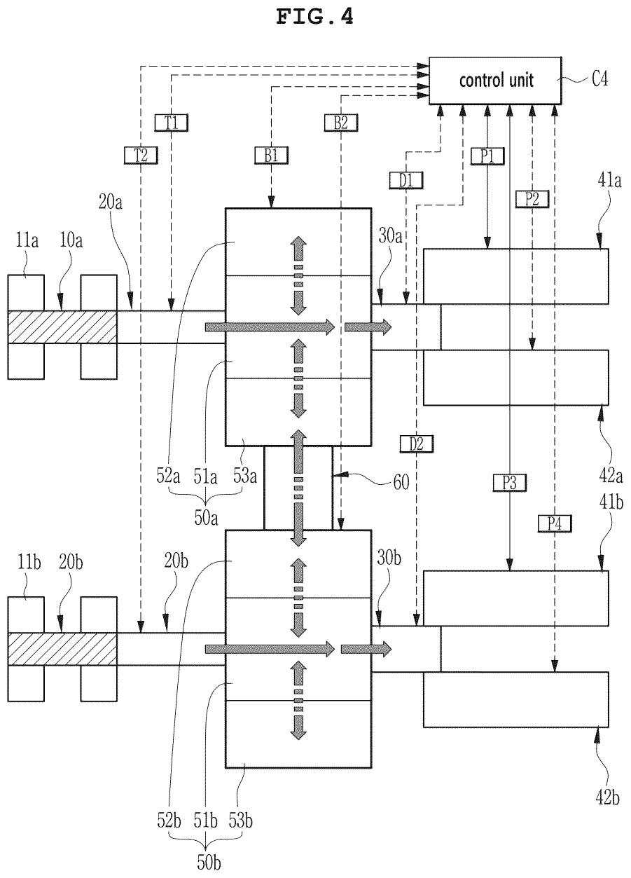

FIG. 3 is a schematic view illustrating a secondary battery manufacturing system according to another embodiment of the present disclosure; and FIG. 4 is a schematic view illustrating a secondary battery manufacturing system according to a modified example of another embodiment of the present disclosure.

A secondary battery manufacturing system according to another embodiment of the present disclosure includes: a first manufacturing line including a first tab welding unit 20a configured to perform a welding process on an electrode tab of an electrode assembly and insert the electrode assembly into a transfer cassette 70, a first inspection unit 30a configured to inspect the electrode assembly, first packaging units 41a and 42a provided in parallel for inserting the electrode assembly that has passed the first inspection unit 30a into a pouch, and a first buffer unit 50a configured to transfer the transfer cassette 70 from the first tab welding unit 20a to the first inspection unit 30a or store the transfer cassette 70; a second manufacturing line including a second tab welding unit 20b configured to perform a welding process on an electrode tab of an electrode assembly and insert the electrode assembly into a transfer cassette 70, a second inspection unit 30b configured to inspect the electrode assembly, second packaging units 41b and 42b provided in parallel for inserting the electrode assembly that has passed the second inspection unit 30b into a pouch, and a second buffer unit 50b configured to transfer the transfer cassette 70 from the second tab welding unit 20b to the second inspection unit 30b or store the transfer cassette 70; a buffer connection unit 60 configured to connect the first buffer unit 50a and the second buffer unit 50b; and at least one control unit C3 configured to transfer the transfer cassette 70 of the first tab welding unit 20a to the first inspection unit 30a or the second inspection unit 30b and transfer the transfer cassette 70 of the second tab welding unit 20b to the first inspection unit 30a or the second inspection unit 30b, and to selectively supply the electrode assembly that has passed the first inspection unit 30a to one of the first packaging units 41a and 42a and selectively supply the electrode assembly that has passed the second inspection unit 30b to one of the second packaging units 41b and 42b.

The secondary battery manufacturing system according to another embodiment of the present disclosure is a case in which the secondary battery manufacturing system of an embodiment of the present disclosure, which has already been described above, consists of a plurality of manufacturing lines. In another embodiment of the present disclosure, a first manufacturing line and a second manufacturing line are described, but this includes a case where a plurality of manufacturing lines are added, and is not limited to a secondary battery manufacturing system that simply consists of two manufacturing lines.

As shown in FIG. 3, the first manufacturing line includes the first tab welding unit 20a, the first inspection unit 30a, the first packaging units 41a and 42a, and the first buffer unit 50a, while the second manufacturing line includes the second tab welding unit 20b, the second inspection unit 30b, the second packaging units 41b and 42b, and the second buffer unit 50b. The buffer connection unit 60 for mutual transfer of the transfer cassettes 70 of the first manufacturing line and the second manufacturing line is further included. In addition, at least one control unit C3 is included to control the entire manufacturing line system of the first manufacturing line and the second manufacturing line.

The first tab welding unit 20a and the second tab welding unit 20b are components corresponding to the tab welding unit 20 described above, the first inspection unit 30a and the second inspection unit 30b are components corresponding to the inspection unit 30 described above, the first packaging units 41a and 42a and the second packaging units 41b and 42b are components corresponding to the packaging units 41 and 42 described above, and the first buffer unit 50a and the second buffer unit 50b are components corresponding to the buffer unit 50 described above, and thus descriptions of specific functions and operations thereof are omitted to avoid redundancy. The secondary battery manufacturing system according to another embodiment of the present disclosure will be described focusing on the differences in operation between the components and on the additionally included configuration of the buffer connection unit 60.

As shown in FIG. 3, the transfer cassette 70 containing an electrode assembly supplied from the first tab welding unit 20a of the first manufacturing line is transferred to the first inspection unit 30a through the first buffer unit 50a. The electrode assembly that has passed the first inspection unit 30a may be selectively supplied to the first packaging units 41a and 42a under the control of the control unit C3.

The first buffer unit 50a includes: a first transfer buffer part 51a through which the transfer cassette 70 is supplied from the first tab welding unit 20a to the first inspection unit 30a; a 1-1 storage part 52a and a 1-2 storage part 53a of the first buffer unit 50a where the transfer cassette 70 of the first tab welding unit 20a is stored or waiting.

When the transfer cassette 70 supplied from the first tab welding unit 20a cannot be supplied normally due to the operation of the first inspection unit 30a being stopped, or when the speed of supply to the first inspection unit 30a needs to be adjusted, the control unit C3 may cause the transfer cassette 70 to be transferred to the 1-1 storage part 52a or the 1-2 storage part 53a of the first buffer unit 50a for storage or standby.

In addition, when the operation of the first tab welding unit 20a stops, the control unit C3 may cause the transfer cassette 70 stored or waiting in the 1-1 storage part 52a or the 1-2 storage part 53a of the first buffer unit 50a to be transferred to the first inspection unit 30a, thereby keeping the secondary battery manufacturing system operating smoothly.

Like the first manufacturing line, in the case of the second manufacturing line, the transfer cassette 70 containing an electrode assembly supplied from the second tab welding unit 20b is transferred to the second inspection unit 30b through the second buffer unit 50b. The electrode assembly that has passed the second inspection unit 30b may be selectively supplied to the second packaging units 41b and 42b under the control of the control unit C3.

The second buffer unit 50b includes: a second transfer buffer part 51b through which the transfer cassette 70 is supplied from the second tab welding unit 20b to the second inspection unit 30b; a 2-1 storage part 52b and a 2-2 storage part 53b of the second buffer unit 50b where the transfer cassette 70 of the second tab welding unit 20b is stored or waiting.

When the transfer cassette 70 supplied from the second tab welding unit 20b cannot be supplied normally due to the operation of the second inspection unit 30b being stopped, or when the speed of supply to the second inspection unit 30b needs to be adjusted, the control unit C3 may cause the transfer cassette 70 to be transferred to the 2-1 storage part 52b or the 2-2 storage part 53b of the second buffer unit 50b for storage or standby.

In addition, when the operation of the second tab welding unit 20b stops, the control unit C3 may cause the transfer cassette 70 stored or waiting in the 2-1 storage part 52b or the 2-2 storage part 53b of the second buffer unit 50b to be transferred to the second inspection unit 30b, thereby keeping the secondary battery manufacturing system operating smoothly.

Furthermore, the first manufacturing line and the second manufacturing line may include a process of supplying transfer cassettes 70 to the first packaging units 41a and 42a or the second packaging units 41b and 42b alternately by packaging controllers P1, P2, P3, and P4.

When the first inspection unit 30a of the first manufacturing line stops operating, the control unit C3 may stop the operation of the first packaging units 41a and 42a and transfer the transfer cassettes 70 of the first buffer unit 50a to the second inspection unit 30b through the buffer connection unit 60 where the first buffer unit 50a and the second buffer unit 50b are interconnected. Similarly, when the second inspection unit 30b of the second manufacturing line stops operating, the control unit C3 may stop the operation of the second packaging units 41b and 42b and transfer the transfer cassettes 70 of the second buffer unit 50b to the first inspection unit 30a through the buffer connection unit 60 where the first buffer unit 50a and the second buffer unit 50b are interconnected.

When both the first inspection unit 30a and the second inspection unit 30b stop operating, the control unit C3 may stop the operations of the first packaging units 41a and 42a and the second packaging units 41b and 42b, and store the transfer cassettes 70 supplied from the first welding unit 20a and the second welding unit 20b to the first buffer unit 50a or the second buffer unit 50b. Although, the transfer cassettes may be preferentially transferred, under the control of the packaging controllers P1, P2, P3, and P4, to the buffer unit 50a or 50b closest to each of the tab welding units 20a and 20b and stored in the storage part, depending on the storage capacity of each manufacturing line and whether each manufacturing line is operating normally, the transfer cassettes may be smoothly transferred to the buffer units 50a and 50b of different lines.

When the first tab welding unit 20a stops operating, the control unit C3 may transfer the transfer cassettes stored or waiting in the 1-1 storage part 52a or the 1-2 storage part 53a of the first buffer unit 50a to the first inspection unit 30a. Similarly, when the second welding unit 20b stops operating, the control unit C3 may transfer the transfer cassettes stored or waiting in the 2-1 storage part 52b or the 2-2 storage part 53b of the second buffer unit 50b to the second inspection unit 30b.

When one of the first tab welding unit 20a and the second tab welding unit 20b stops operating or both the first tab welding unit 20a and the second tab welding unit 20b stop operating, the first buffer unit 50a and the second buffer unit 50b may transfer and supply the transfer cassettes 70 to the respective inspection units 30a and 30b of the same manufacturing line, or to the first inspection unit 30a and the second inspection unit 30b of a different manufacturing line, alternately.

In the modified example of another embodiment of the present disclosure, by providing a controller for each drive device, individual drive devices may be controlled through communication between individual controllers, or the communication values may be transmitted to a control unit C4 to control the entire system.

When configuring the individual controllers, the control unit C4 that integrates the individual controllers may be provided, but the entire manufacturing system may be operated through communication between the individual controllers.

To be specific, as shown in FIG. 4, the controllers may include: a first inspection controller D1 and a second inspection controller D2 that respectively control the stopping and operation of the first inspection unit 30a and the second inspection unit 30b; and the packaging controllers P1, P2, P3, and P4 that determine whether each of the respective packaging units 41a, 42a, 41b, and 42b is driven or stopped and communicate with the individual controllers of the driving devices at other stages, and control the driving and stopping of the first packaging units 41a and 42a and the second packaging units 41b and 42b. The controllers may further include: tab welding unit controllers T1 and T2 that control the driving and stopping of the first tab welding unit 20a and the second tab welding unit 20b, respectively; and buffer controllers B1 and B2 that cause the transfer cassettes 70 supplied from the tab welding units 20a and 20b to be stored or to wait in the first and second buffer units 50a and 50b, or determine and control the transfer of the transfer cassettes 70 between the first and second buffer units 50a and 50b and whether to transfer the transfer cassettes 70 to the inspection units 30a and 30b on the basis of mutual communication values.

In addition, when one of the packaging units 41a, 42a, 41b, and 42b stops operating, the inspection controllers D1 and D2 may receive signals from the packaging controllers P1, P2, P3, and P4, and adjust and control the supply speed of the transfer cassettes 70 to the first inspection unit 30a or the second inspection unit 30b.

The method of configuring the control unit into multiple individual controllers and the control range of each controller may be modified by various methods and physical combinations, and are not limited to the examples shown in the present disclosure.

Above, the present disclosure has been described in detail through specific embodiments. The embodiments are for specifically explaining the present disclosure, and the present disclosure is not limited thereto. It should be clear that modifications and improvements can be made by those skilled in the art within the technical spirit of the present disclosure.

All simple modifications or changes of the present disclosure fall within the scope of the present disclosure, and the specific scope of protection of the present disclosure wil be made clear by the appended claims.

What is claimed is:

1. A secondary battery manufacturing system comprising:
a tab welding unit configured to perform a welding process on an electrode tab of an electrode assembly and insert the electrode assembly into a transfer cassette;
an inspection unit configured to inspect the electrode assembly;
packaging units provided in parallel for inserting the electrode assembly that has passed the inspection unit into a pouch;
a buffer unit configured to transfer the transfer cassette from the tab welding unit to the inspection unit or store the transfer cassette; and
at least one control unit configured to control the electrode assembly supplied from the inspection unit to be selectively supplied to any one packaging unit that operates normally depending on whether the packaging units operate normally, and control the transfer cassette to be supplied to the inspection unit that operates normally or stored in the buffer unit depending on whether the inspection unit operates normally.

2. The system of claim 1, wherein the buffer unit comprises:
a transfer buffer part in which the transfer cassette reciprocates between the tab welding unit and the inspection unit;
a first storage part where the transfer cassette is stored; and
a second storage part where the transfer cassette is stored.

3. The system of claim 2, wherein the control unit further comprises:
a buffer controller configured to transfer the transfer cassette of the first storage part or the second storage part to the inspection unit when the tab welding unit stops operating.

4. The system of claim 2, wherein the control unit further comprises:
a buffer controller configured to transfer the transfer cassette to the first storage part or the second storage part when the inspection unit stops operating and the packaging units stop operating.

5. The system of claim 2, wherein the control unit further comprises:
an inspection controller configured to control a supply speed of the transfer cassette to the inspection unit when at least one of the packaging units stops operating.

6. A secondary battery manufacturing system comprising:
a first manufacturing line comprising: a first tab welding unit configured to perform a welding process on an electrode tab of an electrode assembly and insert the electrode assembly into a transfer cassette; a first inspection unit configured to inspect the electrode assembly; first packaging units provided in parallel for inserting the electrode assembly that has passed the first inspection unit into a pouch; and a first buffer unit configured to transfer the transfer cassette from the first tab welding unit to the first inspection unit or store the transfer cassette;
a second manufacturing line comprising: a second tab welding unit configured to perform a welding process on an electrode tab of an electrode assembly and insert the electrode assembly into a transfer cassette; a second inspection unit configured to inspect the electrode assembly; second packaging units provided in parallel for inserting the electrode assembly that has passed the second inspection unit into a pouch; and a second buffer unit configured to transfer the transfer cassette from the second tab welding unit to the second inspection unit or store the transfer cassette;
a buffer connection unit configured to connect the first buffer unit and the second buffer unit; and
at least one control unit configured to transfer the transfer cassette of the first tab welding unit to the first inspection unit or the second inspection unit and transfer the transfer cassette of the second tab welding unit to the first inspection unit or the second inspection unit, and to selectively supply the electrode assembly that has passed the first inspection unit to one of the first packaging units and selectively supply the electrode assembly that has passed the second inspection unit to one of the second packaging units.

7. The system of claim 6, wherein the first buffer unit comprises: a first transfer buffer part in which the transfer cassette reciprocates between the first tab welding unit and the first inspection unit; and a 1-1 storage part and a 1-2 storage part where the transfer cassette is stored;
the second buffer unit comprises: a second transfer buffer part in which the transfer cassette reciprocates between the second tab welding unit and the second inspection unit; and a 2-1 storage part and a 2-2 storage part where the transfer cassette is stored; and
the buffer connection unit is provided to connect the 1-1 storage part or the 1-2 storage part and the 2-1 storage part or the 2-2 storage part.

8. The system of claim 6, wherein the control unit further comprises:
a buffer controller configured to transfer the transfer cassette of the first buffer unit to the second inspection unit through the buffer connection unit when the first inspection unit of the first manufacturing line stops operating and the first packaging units stop operating, and transfer the transfer cassette of the second buffer unit to the first inspection unit through the buffer connection unit when the second inspection unit of the second manufacturing line stops operating and the second packaging units stop operating, and to store the transfer cassettes of the first tab welding unit and the second tab welding unit in the first buffer unit or the second buffer unit, respectively, when the first inspection unit and the second inspection unit stop operating and the first packaging units and the second packaging units stop operating.

9. The system of claim 7, wherein the control unit further comprises:
a buffer controller configured to transfer the transfer cassette of the 1-1 storage part or the 1-2 storage part of the first buffer unit to the first inspection unit when the first tab welding unit stops operating, and transfer the transfer cassette of the 2-1 storage part or the 2-2 storage part of the second buffer unit to the second inspection unit when the second tab welding unit stops operating.

10. The system of claim 9, wherein the buffer controller transfers the transfer cassette of the first tab welding unit to the 2-1 storage part or the 2-2 storage part of the second buffer unit when the first tab welding unit operates and the second tab welding unit stops operating.

11. The system of claim 6, wherein the control unit further comprises:
a buffer controller configured to transfer at least one transfer cassette stored in the 1-1 storage part or the 1-2 storage part of the first buffer unit and in the 2-1 storage part or the 2-2 storage part of the second buffer unit to the first inspection unit or the second inspection unit when the first tab welding unit and the second tab welding unit stop operating.
